(19) United States
(12) Patent Application Publication
(10) Pub. No.: US 2006/0177126 A1
(43) Pub. Date: Aug. 10, 2006

(54) Apparatus for compensating image according to probabilistic neural network theory and method thereof

(75) Inventor: Hong-Gyu Han, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/245,087

(22) Filed: Oct. 7, 2005

(30) Foreign Application Priority Data
Feb. 4, 2005 (KR) 2005-0010745

(51) Int. Cl. G06K 9/62; G06K 9/40

(52) U.S. Cl. 382/156; 382/254

(57) ABSTRACT

An apparatus for compensating an image by using a probabilistic neural network theory and a method thereof are disclosed. The image compensating apparatus includes: an error pixel detecting unit for detecting an error pixel generating an error among pixels included in a current image frame; and a neural network unit for storing a learning result of the current image frame by learning the current image frame and estimating a pixel value of the error pixel detected form the error pixel detecting unit by using the learning result of a previous image frame. The apparatus and method provides a high quality image to a user and can facilitate an artificial intelligence (AI) image compensating apparatus.

### PRIORITY

This application claims the benefit under 35 U.S.C. §119(a) of Korean Patent Application No. 2005-10745, filed on Feb. 4, 2005, in the Korean Intellectual Property Office, the entire contents of which are incorporated herein by reference.

### BACKGROUND OF THE INVENTION

1. Field of the Invention

The present invention relates to an apparatus for compensating an image and a method thereof. More particularly, the present invention relates to an apparatus for compensating an error in an image by using a probabilistic neural network theory and a method thereof.

2. Description of the Related Art

Errors can occur while reading an image signal recorded in a recording medium or transmitting/receiving the image signal through a wired/wireless communication network. If an image signal includes errors, faulty images are reproduced from the image signal or quality of the reproduced image may be seriously deteriorated.

For overcoming the above-mentioned problem, the errors included in the image signal must be compensated for before reproducing the image signal. Recently, there are many studies in progress for introducing or developing schemes for compensating for errors, and many introduced schemes are already applied to a system.

Users demand to obtain very high quality images and, thus, a new improved compensating scheme is required for providing high quality images for satisfying the users' demand.

Furthermore, various artificial intelligence electronic devices are recently introduced and developed. A need therefore exists for an artificial intelligence compensation scheme for providing high quality images.

### SUMMARY OF THE INVENTION

Accordingly, the present invention has been made to solve the above-mentioned problems, and an aspect of the present invention is to provide an apparatus for compensating for an error in an image by using a probabilistic neural network theory and a method thereof for providing very high quality images.

In accordance with an aspect of the present invention, there is provided an image compensating apparatus comprising: an error pixel detecting unit for detecting an error pixel generating an error among pixels included in a current image frame; and a neural network unit for storing a learning result of the current image frame by learning the current image frame and estimating a pixel value of the error pixel detected form the error pixel detecting unit by using the learning result of a previous image frame.

In accordance with an aspect of the present invention, the neural network unit comprises: a learning unit for generating a one-to-one relationship between a pixel value of a pixel and a neighboring pixel value group of the pixel for each of pixels included in the current image frame as the learning result of the current image frame, wherein the neighboring pixel value group is a set of pixel values of neighboring pixels of the pixel; a learning result storing unit for storing the generated learning result of the current image frame from the learning unit and storing a learning result of the previous image frame; and an error pixel compensating unit for estimating a pixel value of the error pixel detected from the detecting unit by referring to the previous learning result stored in the learning result storing unit.

In accordance with another aspect of the present invention, the neighboring pixels of the pixel may be pixels arranged around the pixel within a predetermined pattern.

In accordance with another aspect of the present invention, the neighboring pixels of the pixel may be a portion of pixels arranged in a left side area of the pixel and an upper side area of the pixel.

In accordance with another aspect of the present invention, the error pixel compensating unit may search a neighboring pixel value group identical to a neighboring pixel value group of the error pixel in the learning result of the previous image frame stored in the learning result storing unit, and may estimate a pixel value of the error pixel as a pixel value corresponding to the searched neighboring pixel value group.

In accordance with another aspect of the present invention, the error pixel compensating unit may search a neighboring pixel value group most similar to a neighboring pixel value group of the error pixel in the learning result of the previous image frame stored in the learning result storing unit when there is no substantially identical neighboring pixel value group in the learning result of the previous image frame, and may estimate a pixel value of the error pixel as a pixel value corresponding to the searched neighboring pixel value group.

In accordance with another aspect of the present invention, the most similar neighboring pixel value group may be a neighboring pixel value group including the largest number of pixel values identical to the pixel values in the neighboring pixel value group of the current image frame.

In accordance with another aspect of the present invention, there is provided an image compensating method comprising the steps of: a) generating a learning result of a current image frame by learning the current image frame; b) storing the generated learning result of the current image frame; c) detecting an error pixel, where an error is generated, among pixels constructing the current image frame; and d) estimating a pixel value of the detected error pixel by using the learning result of a previous image frame.

In accordance with another aspect of the present invention, in the step a), a one-to-one relationship between a pixel value of a pixel and a neighboring pixel value group of the pixel, which is a set of pixel values of neighboring pixels of the pixel, may be generated for each of the pixels included in the current image frame as the learning result of the current image frame.

In accordance with another aspect of the present invention, neighboring pixels of the pixel may be pixels arranged around the pixel within a predetermined pattern.

In accordance with another aspect of the present invention, the neighboring pixels of the pixel may be a portion of pixels arranged in a left side area of the pixel and an upper side area of the pixel.

In accordance with another aspect of the present invention, in the step d), a neighboring pixel value group identical to a neighboring pixel value group of the error pixel may be searched in the learning result of the previous image frame stored in the learning result storing unit, and a pixel value of the error pixel may be estimated as a pixel value corresponding to the searched neighboring pixel value group.

In accordance with another aspect of the present invention, in the step d), a neighboring pixel value group most similar to a neighboring pixel value group of the error pixel may be searched in the learning result of the previous image frame stored in the learning result storing unit when there is no substantially identical neighboring pixel value group in the learning result of the previous image frame, and the pixel value of the error pixel may be estimated as a pixel value corresponding to the searched neighboring pixel value group.

The most similar neighboring pixel value group may be a neighboring pixel value group including the largest number of pixel values substantially identical to the pixel values in the neighboring pixel value group of the pixel.

### BRIEF DESCRIPTION OF THE DRAWINGS

The above aspects and features of the present invention will become apparent and more readily appreciated from the following description of the preferred embodiments, taken in conjunction with the accompanying drawings, in which:

FIG. 1 is a block diagram illustrating an apparatus for compensating an image by using a probabilistic neural network theory in accordance with an exemplary embodiment of the present invention;

FIG. 2 is a flowchart showing a method of compensating an image by using a probabilistic neural network theory in accordance with an exemplary embodiment of the present invention;

FIGS. 3A to 3C shows image frames including a plurality of pixels for explaining learning of a current image frame in accordance with an embodiment of the present invention;

FIG. 4 is a table showing a learning result stored in a learning result storing unit in accordance with an embodiment of the present invention; and

FIGS. 5A and 5B shows image frames for explaining estimating pixel values in accordance with an embodiment of the present invention.

Throughout the drawings, the same or similar elements are denoted by the same reference numerals.

### DETAILED DESCRIPTION OF THE EXEMPLARY EMBODIMENTS

Certain embodiments of the present invention will be now described in greater detail with reference to the accompanying drawings. Also, well-known functions or constructions are not described in detail since they would obscure the invention in unnecessary detail.

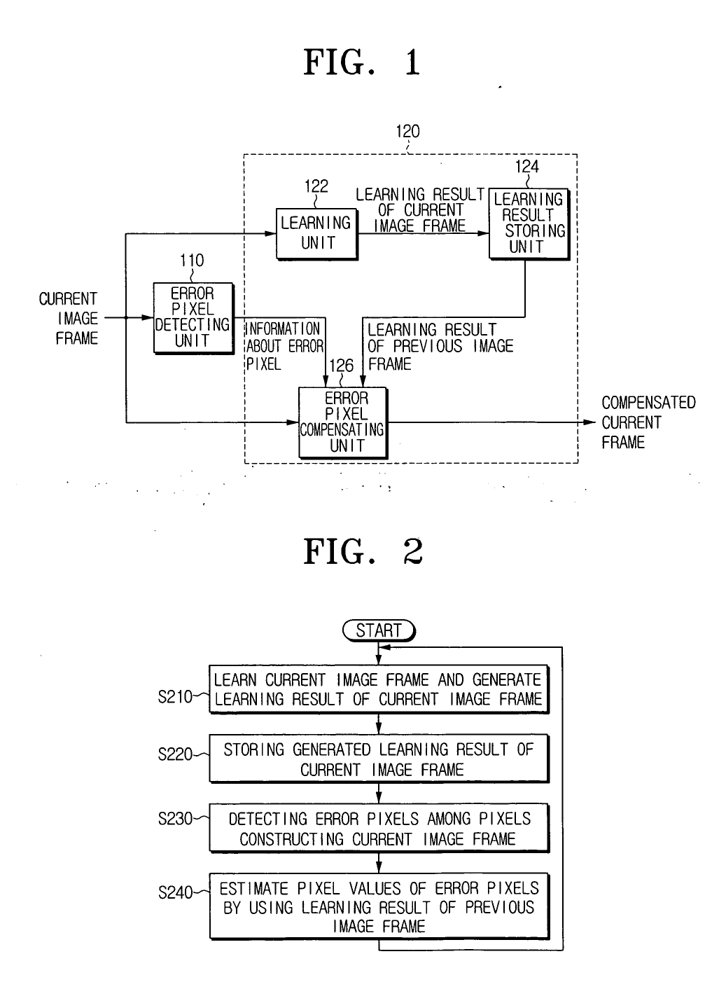

FIG. 1 is a block diagram illustrating an apparatus for compensating an image in accordance with an exemplary embodiment of the present invention. The apparatus of the present embodiment compensates errors in an image implementing a probabilistic neural network theory.

Referring to FIG. 1, the apparatus for compensating errors in an image comprises an error pixel detecting unit 110 and a neural network unit 120.

The error pixel detecting unit 110 detects error pixels among pixels in an inputted current image frame. The error pixel detecting unit 10 transfers information about the detected error pixels to the neural network unit 120.

The term of “error pixel” refers to a pixel where an error is generated. That is, the error pixel is a pixel that cannot be normally reproduced because pixel value data is damaged or the pixel value data includes errors. Accordingly, the pixel value of the error pixel is estimated, and the error pixel is reproduced based on the estimated pixel value.

The neural network unit 120 learns an inputted image frame according to an illustrative probabilistic neural network theory and compensates errors in an image based on the result of learning. Accordingly, the neural network unit 120 outputs an error-compensated image frame. The neural network unit 120 comprises a learning unit 122, a learning result storing unit 124 and an error pixel compensating unit 126.

The learning unit 122 generates a learning result of a current image frame by learning the currently inputted image frame and stores the generated learning result in the learning result storing unit 124.

The learning result storing unit 124 is preferably a storing medium for storing the learning result of the current image frame that is currently generated at the learning unit 122. The learning result storing unit 124 also stores previously generated learning results from the learning unit 122.

A previously generated learning result is a learning result of a previous image frame generated from the learning unit 122. The previous image frame is an image frame previously inputted to the current image frame.

The error pixel compensating unit 126 compensates for an error pixel by using information about error pixels of the current image frame transferred from the error pixel detecting unit 110 and the learning result of the previous image frame stored in the learning result storing unit 124. The error pixel compensating unit 126 estimates pixel values of the error pixels by referring to the learning result of the previous image frame stored in the learning result storing unit 124.

Hereinafter, a method of compensating errors in an image by applying a probabilistic neural network theory in accordance with an exemplary embodiment of the present invention will be explained with reference to FIG. 2.

FIG. 2 is a flowchart illustrating a method of compensating for errors in an image by applying a probabilistic neural network theory in accordance with an exemplary embodiment of the present invention.

Referring to FIG. 2, the learning unit 122 generates a learning result of a current image frame by learning the currently inputted image frame at step S210. The generated learning result is stored in the learning result storing unit 124 at step S220.

In the step S210, the learning unit 122 generates a relationship between a pixel value of each pixel in the current image frame and a neighboring pixel value group of the pixel as the learning result. The learning unit 122 generates relationships for several and preferably all pixels in the current image frame.

The neighboring pixel value group is a set of pixel values of pixels around a pixel. And, neighboring pixels are pixels around a pixel within a predetermined pattern. That is, the neighboring pixels may form the predetermined pattern.

There is no limitation for the predetermined pattern formed by the neighboring pixels. However, because the image processing progresses from a left side to a right side of the image frame, and from an upper side to a bottom side of the image frame, it is preferable that the pattern is formed with a portion of neighboring pixels arranged on the left area and an upper area of a base pixel.

Before describing steps S230 and S240, generation of relationship between a pixel value of each pixel and a neighboring pixel value group of the pixel will first be explained in accordance with an exemplary embodiment of the present invention.

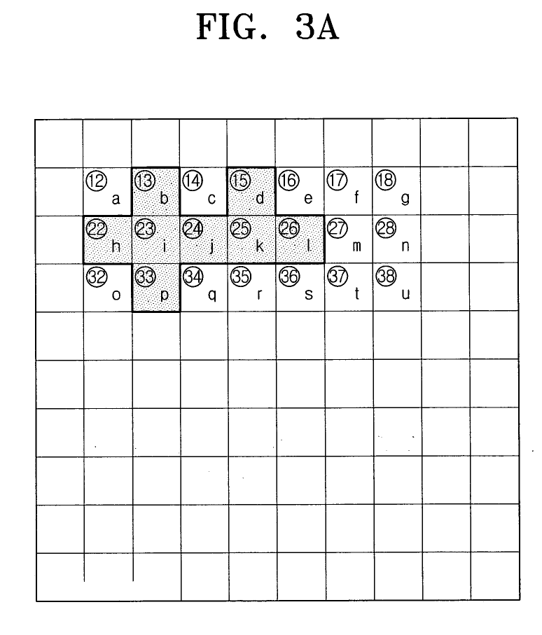

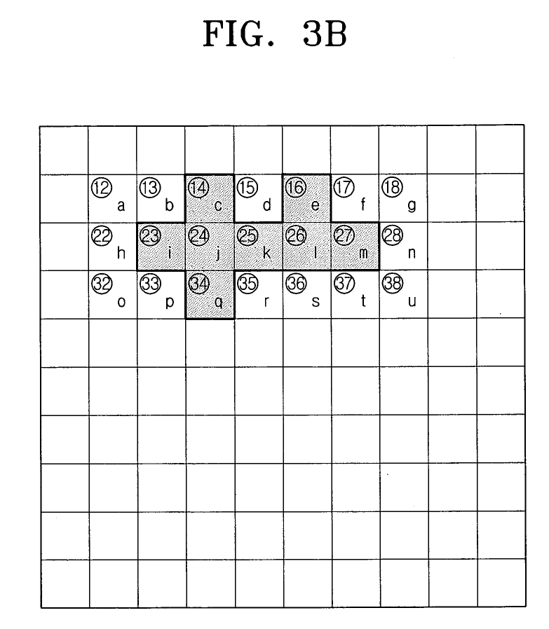

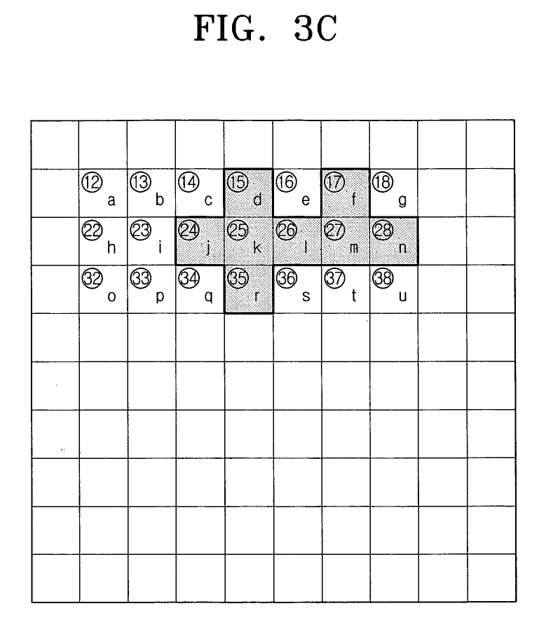

As shown in FIG. 3A, it is assumed that a pixel value of each pixel is a small letter written in a corresponding pixel. It is also assumed that there are eight neighboring pixels arranged around a base pixel, and the neighboring pixels are arranged at one pixel left and two pixels upward from the base pixel, one pixel right and two pixels upward from the base pixel, and two pixels left and one pixel upward from the base pixel, and one pixel left and one pixel upward from the base pixel, and one pixel upward from the base pixel, and one pixel right and one pixel upward from the base pixel, and two pixels right and one pixel upward from the base pixel, and one pixel left of the base pixel. As shown in FIG. 3A, the neighboring pixels form a pattern with oblique lines.

Neighboring pixels of a pixel 34 comprise pixels arranged in an oblique lined-pattern, i.e., a pixel 13, a pixel 15, a pixel 22, a pixel 23, a pixel 24, a pixel 25, a pixel 26 and a pixel 33.

Accordingly, the neighboring pixel value group of the pixel 34 is b, d, h, i, j, k, l, and p, and a pixel value of the pixel 34 is q. Therefore, a relationship between the pixel value of the pixel 34 and the neighboring pixel value group of the pixel 34 is expressed as [(b, d, h, i, j, k, l, p),(q)].

Referring to FIG. 3b, a relationship between a pixel value of a pixel 35 and a neighboring pixel value group of the pixel 35 is expressed as [(c, e, i, j, k, l, m, q), (r)]. Also, referring to FIG. 3c, a relationship between a pixel value of a pixel 36 and a neighboring pixel value group of the pixel 36 is expressed as [(d, f, j, k, l, m, n, r), (s)].

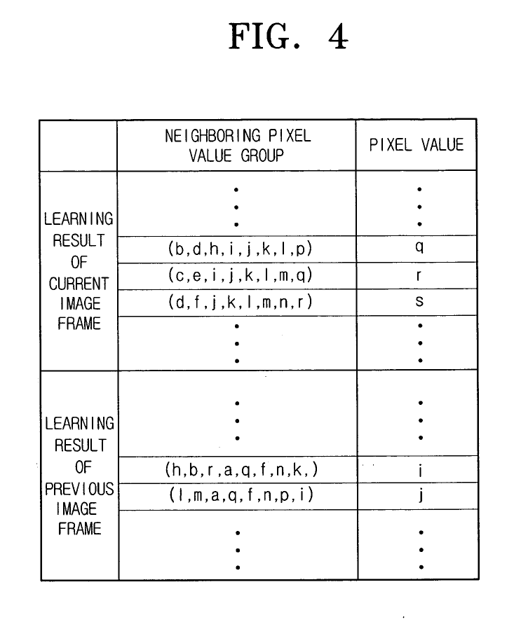

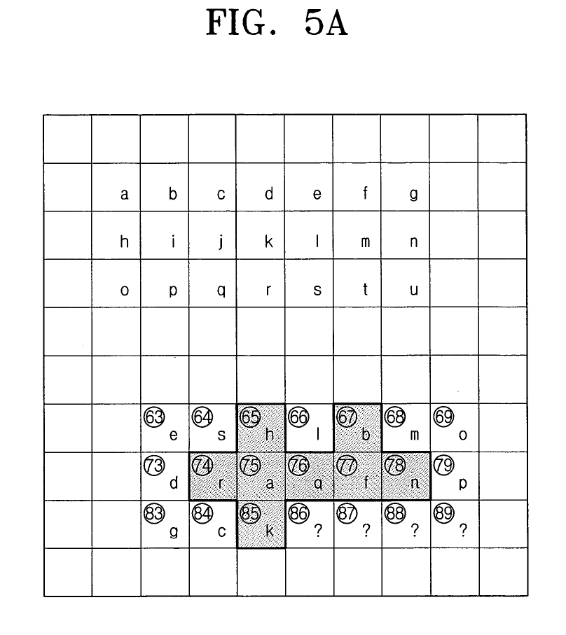

Such a relationship is stored in the learning result storing unit 124 as the learning result of the current image frame. In FIG. 4, an exemplary learning result of the current image frame stored in the learning result storing unit 124 is shown. Meanwhile, since a learning result of the previous image frame is previously in the learning result storing unit 124, FIG. 4 also shows the learning result of the previous image frame at bottom of the learning result of the current image frame.

Referring to FIG. 2 again, the error pixel detecting unit 110 detects error pixels among pixels of the current image frame at step S230. The information about the detected pixels is transferred to the error pixel compensating unit 126.

The error pixel compensating unit 126 estimates pixel values of the error pixels by referring to the learning result of the previous image frame stored in the learning result storing unit 124 at step S240.

In the step S240, the error pixel compensating unit 126 searches a neighboring pixel value group at least substantially identical to a neighboring pixel value group of the error pixel in the learning result of the previous image frame stored in the learning result storing unit 124. After searching, the error pixel compensating unit 126 estimates the pixel value of the error pixel as a pixel value corresponding to the searched neighboring pixel value group.

Hereinafter, estimating the pixel values of the error pixels in accordance with an exemplary embodiment of the present invention will be explained.

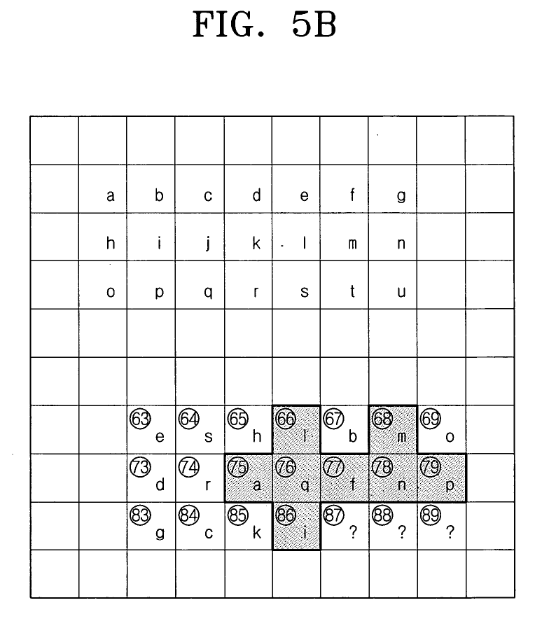

As shown in FIG. 5A, it is assumed that a pixel 86, a pixel 87, a pixel 88 and a pixel 89 are error pixels. Pixel values of the error pixels are currently unknown so the pixel values of the error pixels are expressed as ‘?’.

For estimating a pixel value of the pixel 86, the error pixel compensating unit 126 obtains a neighboring pixel value group of the pixel 86 at first. As shown in FIG. 5B, the neighboring pixel value group of the pixel 86 is expressed as (h, b, r, a, q, f, n, k).

The error pixel compensating unit 126 searches a neighboring pixel value group identical substantially to the neighboring pixel value group of the pixel 86 in the learning result of the previous image frame and estimates the pixel value of the pixel 86 as a pixel value corresponding to the searched neighboring pixel value group.

As shown the learning result of the previous image frame stored in the learning result storing unit 124 in FIG. 4, the pixel value corresponding to the searched neighboring pixel value group that is substantially identical to the neighboring pixel value group (h, b, r, a, q, f, n, k) of the pixel 86 is i. Therefore, the error pixel compensating unit 126 estimates the pixel value of the pixel 86 is i.

The pixel error compensating unit 126 estimates a pixel value of the pixel 87 based on the above described method. As shown in FIG. 5B, a neighboring pixel value group of the pixel 87 is (l, m, a, q, f, n, p, i). As shown in FIG. 4, a pixel value corresponding to the neighboring pixel value group substantially identical to (l, m, a, q, f, n, p, i) is j. As a result, the error pixel compensating unit 126 estimates a pixel value of the pixel 87 as j.

The error pixel compensating unit 126 estimates pixel values of the pixel 88 and the pixel 89 based on the above described method.

Meanwhile, there may be no neighboring pixel value group identical to a neighboring pixel value group of an error pixel in a learning result of the previous image frame.

In this case, the error pixel compensating unit 126 searches a neighboring pixel value group most similar to a neighbor pixel value group of an error pixel and may estimate a pixel value of an error pixel as a pixel value corresponding to the most similar neighboring pixel value group. The most similar neighboring pixel value group may be a neighboring pixel value group having the largest number of neighboring pixel values identical to the neighboring pixel values of the error pixel.

For example, when (l, m, a, q, f, n, p, i) is not included in the learning result of the previous image frame and (l, m, a, q, f, n, x, y) and (l, m, a, q, f, n, p, y) are included in the learning result of the previous image frame, (l, m, a, q, f, n, p, y) is the most similar neighboring pixel value group of the error pixel. It is because the number of identical pixel values in (l, m, a, q, f, n, x, y) is 6 and the number of identical pixel values in (l, m, a, q, f, n, p, i) is 7.

Until now, the method of compensating errors in an image is explained. Meanwhile, the learning result of the current image frame, which is generated in the step S210 and stored in the learning result storing unit 124 in the step S220, is used for estimating pixel values of error pixels of next image frame. The next image frame is the frame inputted after the current image frame.

The apparatus for compensating an image according to the present embodiment can be implemented in an image reproducing apparatus. The image reproducing apparatus may include, but is not limited to, a television (TV), a set top box, a handheld terminal, an optical recording medium reproducing apparatus, a magnetic recording medium reproducing apparatus and a semiconductor recording medium reproducing apparatus. The handheld terminal may be a mobile phone or a personal digital assistant. The optical recording medium reproducing apparatus may be a digital video disk player (DVDP). The magnetic recording medium reproducing apparatus may be a hard disk drive (HDD) reproducing apparatus and a video cassette recorder (VCR). The semiconductor recording medium reproducing apparatus may be a memory card reproducing apparatus.

As described above, errors in an image can be compensated by applying a probabilistic neural network theory according to the present embodiment. Accordingly, super high quality of image can be provided to a user. The present embodiment may also be applied to an artificial intelligent image compensating apparatus.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. An image compensating apparatus, comprising:
an error pixel detecting unit for detecting an error pixel generating an error among pixels included in a current image frame; and
a neural network unit for storing a learning result of the current image frame by learning the current image frame and estimating a pixel value of the error pixel detected from the error pixel detecting unit by using the learning result of a previous image frame.

2. The image compensating apparatus of claim 1, wherein the neural network unit comprises:
a learning unit for generating a one-to-one relationship between a pixel value of a pixel and a neighboring pixel value group of the pixel for each of pixels included in the current image frame as the learning result of the current image frame, wherein the neighboring pixel value group is a set of pixel values of neighboring pixels of the pixel;
a learning result storing unit for storing the generated learning result of the current image frame from the learning unit and storing a learning result of the previous image frame; and
an error pixel compensating unit for estimating a pixel value of the error pixel detected from the detecting unit by referring to the previous learning result stored in the learning result storing unit.

3. The image compensating apparatus of claim 2, wherein the neighboring pixels of the pixel are pixels arranged around the pixel within a predetermined pattern.

4. The image compensating apparatus of claim 2, wherein the neighboring pixels of the pixel is at least a portion of the pixels arranged in a left side area of the pixel and an upper side area of the pixel.

5. The image compensating apparatus of claim 2, wherein the error pixel compensating unit searches a neighboring pixel value group substantially identical to a neighboring pixel value group of the error pixel in the learning result of the previous image frame stored in the learning result storing unit, and estimates a pixel value of the error pixel as a pixel value corresponding to the searched neighboring pixel value group.

6. The image compensating apparatus of claim 5, wherein the error pixel compensating unit searches a neighboring pixel value group most similar to a neighboring pixel value group of the error pixel in the learning result of the previous image frame stored in the learning result storing unit when there is no substantially identical neighboring pixel value group in the learning result of the previous image frame, and estimates a pixel value of the error pixel as a pixel value corresponding to the searched neighboring pixel value group.

7. The image compensating apparatus of claim 6, wherein the most similar neighboring pixel value group is a neighboring pixel value group including the largest number of pixel values substantially identical to the pixel values in the neighboring pixel value group of the error pixel.

8. An image compensating method, comprising the steps of:
a) generating a learning result of a current image frame by learning the current image frame;
b) storing the generated learning result of the current image frame;
c) detecting an error pixel, where an error is generated, among pixels constructing the current image frame; and
d) estimating a pixel value of the detected error pixel by using the learning result of a previous image frame.

9. The image compensating method of claim 8, wherein in the step a), a one-to-one relationship between a pixel value of a pixel and a neighboring pixel value group of the pixel is generated for each of the pixels included in the current image frame as the learning result of the current image frame, wherein the neighboring pixel value group is a set of pixel values of neighboring pixels of the pixel.

10. The image compensating method of claim 9, wherein neighboring pixels of the pixel are pixels arranged around the pixel within a predetermined pattern.

11. The image compensating method of claim 9, wherein the neighboring pixels of the pixel are a portion of pixels arranged in a left side area of the pixel and an upper side area of the pixel.

12. The image compensating method of claim 9, wherein in the step d), a neighboring pixel value group identical to a neighboring pixel value group of the error pixel is searched in the learning result of the previous image frame, and a pixel value of the error pixel is estimated as a pixel value corresponding to the searched neighboring pixel value group.

13. The image compensating method of claim 12, wherein the step d), a neighboring pixel value group most similar to a neighboring pixel value group of the error pixel is searched in the learning result of the previous image frame when there is no substantially identical neighboring pixel value group in the learning result of the previous image frame, and the pixel value of the error pixel is estimated as a pixel value corresponding to the searched neighboring pixel value group.

14. The image compensating method of claim 13, wherein the most similar neighboring pixel value group is a neighboring pixel value group including the largest number of pixel values substantially identical to the pixel values in the neighboring pixel value group of the error pixel.
